(19) United States
(12) Patent Application Publication
(10) Pub. No.: US 2012/0276987 A1
(43) Pub. Date: Nov. 1, 2012

(54) Method and System for Wagering on Races

(75) Inventor: Eduardo R. Sanchez, Caracas (VE)

(73) Assignee: ARES SUN GLOBAL USA, INC., Miami, FL (US)

(21) Appl. No.: 13/457,318

(22) Filed: Apr. 26, 2012

Related U.S. Application Data
(60) Provisional application No. 61/479,178, filed on Apr. 26, 2011.

(51) Int. Cl. G06F 17/00

(52) U.S. Cl. 463/26

(57) ABSTRACT

The method and system allow players to wager on races, in particular horseraces. The game tracks winning entries, placing entries, and showing entries over a series of races. Points are accumulated for picking winning horses, placing horses, and showing entries. A winner or winners is/are chosen by accumulating the highest total of points over the series of races. A first carryover pool made from a portion of the stake can be awarded whenever there is only one winning player who has the highest point total. A second carryover pool made from a further portion of the stake can be awarded whenever there is only one winning player who has made a set of picks that results in the highest possible number of points. The system encourages players to stay for a series of races and to return to subsequent events.

### CROSS-REFERENCE TO RELATED APPLICATIONS

This application claims the benefit of U.S. Provisional Application No. 61/479,178, filed Apr. 26, 2011.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to games for wagering on races and in particular to wagering on horse races.

2. Description of the Related Art

A pick six is a type of wager offered by horse racing tracks. It requires bettors to select the winners of six consecutive races. Because of the great difficulty in picking six straight winners, plus the number of betting interests involved, payoffs for successful wagers are quite high, sometimes in the millions of dollars.

The pick six has its roots in the daily double, the first so-called “exotic” wager offered by horse tracks. To win the daily double, a bettor must pick the winner of two consecutive races, traditionally the first two and the last two races of the program. The pick six merely extends this principle. The wager is offered once per program, and is usually offered on six races which conclude with the featured race of the day.

The wager is conducted in pari-mutuel fashion, with all pick six bets going into a separate pool from other kinds of betting. There is one “betting interest” for each available combination, and the number of combinations is equal to the product of the number of runners in all six races. A simplified example: If there are ten horses in each of the six races, then the number of combinations is 10×10×10×10×10×10, or 1,000,000.

The pick six wager actually has two payoffs, one for bettors who pick all six winners, and a smaller payoff for those who pick five out of six. The total pick six betting pool is divided by percentage between the two payouts, along the lines of 75% for the six-winner pool and 25% for the five-winner pool.

Because of the sheer difficulty of successfully choosing six straight winners, plus the large number of betting interests, it is common for there to be no winning wager on all six races. When that happens, the six-winner portion of the pool carries over to the following program, and continues to carry over until it is won. This allows the “carryover pool” to grow to large sums, and tracks usually publicize the fact that their carryover pool has grown to six or seven figures. The five-winner pool is paid out each day, however; if no bettors have chosen five out of six winners, then those who have chosen four winners are paid, or even just three winners (which has happened when a series of long shots have won races). The pick six pool is also paid out in its entirety on a designated date, such as the last day of a race meet or a day with a guaranteed minimum pool; if there are no six-winner tickets, then the pool is split among five-winner tickets.

Because of the huge number of betting interests involved, bettors will often try to increase their chances of winning by selecting multiple combinations. This can be costly. A bettor who wants to cover two horses in each race must bet on 2×2×2×2×2×2 combinations, or sixty-four (64) combinations, times $2 for each for a total of $128. This method is called “boxing horses,” and is also used with other wagers such as a trifecta or superfecta.

Some punters use a multiple ticket strategy combined with one or more singles (legs in which they have only selected a single runner). They have in effect constructed multiple scenarios many of which they know in advance will lose. The point being that, with each successive leg, as the exotic pick six pool sheds tickets, they have several tickets that are still “live” and have a chance of winning the bet or percentage thereof (in some countries e.g. South Africa, punters are allowed to play a percentage of the bet making it cheaper than in the U.S. where a single line is a minimum of $2). Several punters construct these multiple combinations manually and others use pick six software to assist in the process of construction. The critical components of any strategy invariably revolve around handicapping correctly (picking the contenders) and correctly constructing multiple ticket combinations.

Late scratches. Because all pick six wagers must be made before the first of the six races, there are many times when a horse is scratched from a race well after the wager is placed. How this is handled varies according to the rules of the racing jurisdiction. In most cases, the track substitutes the horse that is the post time betting favorite (in the “win” betting pools); if the bettor's original horse is a late scratch and the post time favorite wins, then the bettor is considered to have picked the winner for that race. In other cases, the track may declare combinations involving the scratched horse to have “no action,” and the wager is refunded.

Horse racing uses a particular set of terms and jargon. A glossary of terms can be found at http://horseracing.about.com/library/blraceterms.htm and http://www.ildado.com/horse_racing_glossary.html. Terms that are defined with this application should supersede any definitions from outside the application.

### BRIEF SUMMARY OF THE INVENTION

The invention encompasses a method and system for wagering on a race. In a series of races, players (also known as “punters”) pick an entry for each of the races. Points are provided to players for each pick that is a winning entry, placing entry, or showing entry. The most points are given for picking a winning entry. The second most points are awarded for picking a placing entry. The third most points are awarded for picking a showing entry.

A first portion of the pool of bets is distributed to the player or players with the highest score.

A second portion of the pool of bets is given to a player if the player has the highest possible score and if the player is the only player with that highest possible score. If no one wins the second portion, the second portion rolls over to the subsequent game and is added to the subsequent game's second portion.

A third portion of the pool is given to a player if the player has a unique high score. A unique high score occurs when one and only one player scores the highest score. If no player wins the third portion, the third portion rolls over to the next game and is added to the subsequent game's third portion.

A system tracks and organizes the bets and calculates the winners and payouts. The system can be a computer program written on a computer readable medium such as a hard disk drive. A computer reads the computer readable medium to execute the method according to the invention.

The system includes a computer that collects the picks and bets, prints tickets, calculates winning players, calculates winning dividends, and authenticates winning tickets.

Other features of the invention are set forth in the appended claims.

### BRIEF DESCRIPTION OF THE SEVERAL VIEWS OF THE DRAWING

Not Applicable

### DETAILED DESCRIPTION OF THE INVENTION

ARTICLE 1. A game is based on the following definitions and rules.

ARTICLE 2. The following definitions will be used throughout the rules and regulation unless otherwise specified.

GAME is a set of rules for wagering on VALID RACES, determining WINNERS, and calculating DIVIDENDS.

POINT is a discrete quantity accumulated by picking a WINNING ENTRY, PLACING ENTRY, or SHOWING ENTRY.

SCORE is the points accumulated by a PLAYER in a GAME for a set of PICKS.

BET is a total amount of money that a PLAYER risks.

PLAYER is the person who participates in the GAME. A PLAYER also may be known as a PUNTER.

WINNER is a PLAYER with the most points at the end of the GAME.

UNIQUE WINNER is a PLAYER in the GAME with the most points when there is only one player having the HIGHEST SCORE.

RACETRACK is the location where the RACE is performed.

RACE is a competition (preferably, a horse race) that takes place in a RACETRACK under the control of the SANCTIONING BODY. In preferred embodiment, the RACE is a horse race.

PARTICIPANT is a competitor (e.g. a horse) in a RACE held at a RACETRACK. In a preferred embodiment, the PARTICIPANTS are horses.

OFFICIAL PROGRAM is the guide that establishes the races and the entries enrolled, as well as the dates and start times of the RACES. The OFFICIAL PROGRAM also displays the name of the rider, trainer, proprietors, and other characteristics related to each PARTICIPANT.

COUPLED ENTRY also known as a KEY is when two or more PARTICIPANTS are bundled and treated as one entry in a race. So, if either PARTICIPANT wins, the COUPLED ENTRY wins. However, by choosing a COUPLED ENTRY, the payout is only for one participant.

ENTRY is a PARTICIPANT or COUPLED ENTRY that is a potential bet and that appears in the OFFICIAL PROGRAM that a PLAYER can choose to make a PICK in a given VALID RACE.

MEETING is a set of races that takes place on a determined date displayed in the OFFICIAL PROGRAM of the RACETRACK. A MEETING can include RACES that are not in the GAME. In a preferred embodiment, the final six races in a MEETING are VALID RACES used in the GAME. In an alternative preferred embodiment, VALID RACES are selected to span the greatest number of RACES in a MEETING.

VALID RACE is a RACE in which a PLAYER is allowed to bet in the GAME.

INVALID ENTRY is a PARTICIPANT that was excluded from the GAME although the PARTICIPATE will compete in the RACE.

SCRATCHED ENTRY or scratch is a PARTICIPANT (e.g. a horse) that, even though it appears in the official program, was removed from a RACE before the race starts. In the case of horse racing, trainers may scratch a horse due to adverse track conditions or a horse's health. A veterinarian may scratch a horse at any time.

COMMISSION is a body of officials who judge the RACE and establish the OFFICIAL ORDER OF FINISH.

WINNING ENTRY is an ENTRY that the COMMISSION has determined has won a VALID RACE.

PLACING ENTRY is an ENTRY that the COMMISSION has determined has arrived second in a VALID RACE.

SHOW ENTRY is an ENTRY that the COMMISSION has determined has arrived third in a VALID RACE.

PICKS the set of PARTICIPANTS and or COUPLED ENTRIES selected by a PLAYER for each VALID RACE in a given GAME. A complete PICK includes one and only one PARTICIPANT or COUPLED ENTRY for each VALID RACE.

COMBINATION is a multiple set of PICKS where the PLAYER has chosen more than one PARTICIPANT or COUPLED ENTRY in at least one VALID RACE.

OFFICIAL ORDER OF FINISH is the place of each ENTRY in a given RACE as determined by the COMMISSION and is used to define the WINNING ENTRY, PLACING ENTRY, and SHOW ENTRY for each RACE.

MAXIMUM SCORE is the maximum score possible in a GAME.

HIGHEST SCORE is the highest score earned in the GAME by a PLAYER or PLAYERS.

TICKET is the receipt that contains the PICKS of the PLAYER in the GAME. The TICKET is preferably a printed piece of paper but also could be an electronic receipt.

BET UNIT is the minimum dollar amount that can be bet in each PICK.

DIVIDEND is the payout amount established for each WINNER.

SANCTIONING BODY (also known as a “competent authority”) is an authority that oversees and establishes the RULES for the MEETING. The SANCTIONING BODY typically is a state agency, a private professional society, or the owner of the RACETRACK.

RULES are the regulations that are established and that govern the meetings of races and equestrian activities at the RACETRACK. The RULES are established by the SANCTIONING BODY.

TOTAL SYSTEM is a group of components related to each other for the accomplishment of specific tasks tied to bets derived from racing activity. The TOTAL SYSTEM includes a terminal, software, hardware, and networking (e.g. telecommunications). The TOTAL SYSTEM registers, administers, certifies, and validates the reception of bets from plays or combinations by the SANCTIONING BODY. The TOTAL SYSTEM calculates the DIVIDENDS. The TOTAL SYSTEM tracks the winning tickets. The TOTAL SYSTEM calculates the CARRYOVERS.

PAYOUT PERCENTAGE is the portion of the pool of the TOTAL BETS of all of the PLAYERS that is to be distributed to the WINNER or WINNERS with the HIGH SCORE.

CARRYOVER POOL #1 is a portion of the pool of TOTAL BETS of all of the PLAYERS plus any CARRYOVER POOL #1 not won in the preceding GAME. CARRYOVER POOL #1 is awarded when a UNIQUE WINNER has the HIGHEST POSSIBLE SCORE.

CARRYOVER POOL #2 is a portion of the pool of TOTAL BETS of all of the PLAYERS plus any CARRYOVER POOL #2 not won in the preceding GAME. CARRYOVER POOL #2 is awarded when a UNIQUE WINNER has the HIGHEST SCORE.

ARTICLE 3.

To make a PICK, the PLAYER must choose only one (1) ENTRY in each of the VALID RACES.

To make a COMBINATION, the PLAYER chooses more than one ENTRY in at least one of the VALID RACES.

The PLAYER wins POINTS in each VALID RACE by picking a WINNING ENTRY, PLACING ENTRY, or SHOWING ENTRY.

The addition of the POINTS will determine the SCORE of the PICK.

The POINTS are awarded according to the OFFICIAL ORDER OF FINISH. A first place or “WINNING ENTRY” is awarded the most points. A second place or “PLACING ENTRY” is awarded the second most points. A third place or “SHOW ENTRY” is awarded the third most, generally the least points.

Preferably, the WINNING ENTRY is awarded five (5) POINTS. The PLACING ENTRY is awarded two (2) POINTS. The SHOW ENTRY is awarded one (1) POINT. Entries placing fourth or higher are not awarded any POINTS.

ARTICLE 4. VALID RACES are the only RACES that are considered in the GAME. VALID RACES are listed in the OFFICIAL PROGRAM. The GAME includes a set of VALID RACES. Preferably, the GAME includes at least five VALID RACES. A most preferred embodiment includes exactly six (6) VALID RACES. A set of seven (7) and eight (8) races has been found to work well. Preferably, the GAME includes the final RACE of the MEETING. Preferably, the GAME includes a set of races including the last RACES of the MEETING.

ARTICLE 5. A VALID RACE must have at least three (3) ENTRIES.

ARTICLE 6. If the RULES, null (e.g. cancel or disqualify) one (1) or two (2) VALID RACES in the GAME, zero (0) points will be assigned to each one of the null races. If three (3) or more VALID RACES are nullified, the BETS will be reimbursed to the PLAYER.

ARTICLE 7. When more than a given number, preferably fourteen (14), of entries are registered in a VALID RACE for the GAME, the SANCTIONING BODY may establish COUPLED ENTRIES.

Two or more participants (e.g. horses) that are entered in a RACE can be joined as a COUPLED ENTRY and single betting interest if they are owned or leased in whole or in part by the same owner.

ARTICLE 8. If a PARTICIPANT is scratched, retired, or nullified, the omitted play or combination containing the SCRATCHED ENTRY will be played according to the following rules.

If the SCRATCHED ENTRY is not part of a COUPLED ENTRY, the omitted play or combination will play with the next PARTICIPANT or COUPLED ENTRY that follows the SCRATCHED ENTRY in the ascendant numerical correlative order of the OFFICIAL PROGRAM of the VALID RACES indicated for the GAME.

If the SCRATCHED ENTRY is a part of a COUPLED ENTRY, the game will continue playing with the indicated COUPLED ENTRY with the remaining participant or participants in that COUPLED ENTRY unless all PARTICIPANTS for the COUPLED ENTRY are scratched, in which case, the omitted play or combination will play with the next ENTRY or COUPLED ENTRY that follows the SCRATCHED ENTRY in the ascendant numerical correlative order of the OFFICIAL PROGRAM.

When the SCRATCHED ENTRY is the last one that appears in the OFFICIAL PROGRAM, the SCRATCHED ENTRY will be replaced with the first ENTRY in the OFFICIAL PROGRAM.

When all PARTICIPANTS of the last listed COUPLED ENTRY in the OFFICIAL PROGRAM are scratched, the SCRATCHED ENTRY is replaced with the first ENTRY in the OFFICIAL PROGRAM.

ARTICLE 9. When a Meeting is suspended after the race has been initiated, the remaining races will be deferred to a suitable time in agreement with the RACETRACK, or the SANCTIONING BODY. Only if the race will never be run will the BETS be returned to the player.

ARTICLE 10. If there is a tie in some of the first three (3) places of the OFFICIAL ORDER OF FINISH in one or several VALID RACES, each play or combination that contains the tied PARTICIPANT or COUPLED ENTRY will be awarded the same POINTS.

ARTICLE 11. The COMMISSION or SANCTIONING BODY can null one or more VALID RACES for the GAME as they deem necessary.

ARTICLE 12. For the commercialization of the GAME, specialized machines such as terminals and computer servers can be used as provided by and/or licensed by the SANCTIONING BODY and the OPERATOR.

ARTICLE 13. To make a bet in the GAME, the players will acquire the forms provided by the OPERATOR, or by any company authorized by the OPERATOR. The form can be printed or “virtual” (i.e. a computer program). In an embodiment, the player will be able to directly ask for and dictate verbally to the ticket clerk or representative designated the combination of its preference to be printed.

ARTICLE 14. The form includes one (1) original piece, in which the player selects the PICKS in each VALID RACE. The player will receive a receipt TICKET with the PICKS or COMBINATION. The receipt TICKET can constitute the only valid element for the collection of the DIVIDEND in case of winning. The OPERATOR can modify the ticket format as they deem necessary.

ARTICLE 15. The OPERATOR will choose the bet amount for each PICK. The OPERATOR can notify the SANCTIONING BODY of the BET UNIT.

ARTICLE 16. One or more PICKS or combinations made by the player can be printed on a single TICKET. The plays can be independent as shown in the following METHODS OF BETTING. SIMPLE: the player must select one (1) ENTRY in each VALID RACE. In a preferred embodiment, on the back of the ticket, the chosen ENTRY will appear beneath the number that identifies each VALID RACE. MULTIPLE: the player must select at least two (2) or more ENTRIES in at least one VALID RACE. In a preferred embodiment, on the back of the TICKET, the chosen ENTRY will appear one under the other beneath the number that identifies each VALID RACE.

ARTICLE 17. To calculate the total number of plays or combinations contained in a TICKET, the number of entries selected by the PLAYER in each VALID RACE are multiplied with each other. To calculate the BET AMOUNT, the number of plays or combinations is multiplied by the BET UNIT.

ARTICLE 18. In a preferred embodiment, the TICKET will have on the reverse side the following information: the name of the OPERATOR, the date and hour of the sale, the data of the Sport Book or Location, the day and the date of the MEETING, the number that identifies each VALID RACE, entries selected in each race, total amount of plays or combinations contained in the receipt or ticket, and the total amount paid by the player, expiration date, and a unique and correlative identifier such as a serial number and/or bar code.

ARTICLE 19. Out of the total amount bet in the GAME, a PAYOUT PERCENTAGE, preferably along the lines of 55%, is established and set in the rules of the racing jurisdiction as the daily payout. The payout amount defined by the SANCTIONING BODY is to be distributed proportionally between the WINNERS.

Two carryover pools are created. The pools preferably include 2.5% and 2.5% of the daily played amount and are named CARRYOVER POOL #1 and CARRYOVER POOL #2.

CARRYOVER POOL #1 and CARRYOVER POOL #2 will be awarded exclusively when a UNIQUE WINNER achieves the MAXIMUM SCORE. For example, for a GAME with six (6) VALID RACES, when a MAXIMUM SCORE of 30 is obtained by only one PLAYER, the PLAYER will take CARRYOVER POOL #1 and CARRYOVER POOL #2.

CARRYOVER POOL #2 is given to a UNIQUE WINNER. If there is no UNIQUE WINNER, then CARRYOVER POOL #2 rolls over to the next GAME.

For Example, for a GAME including six (6) VALID RACES, a PLAYER that obtained the unique score of 27 points and no bettors obtained 30 points, will take t CARRYOVER POOL #2. CARRYOVER POOL #1 will be rolled over to the next GAME.

In a different example, if a single PLAYER obtains the MAXIMUM SCORE of 30 points (and no other bettors obtained 30 points), the single PLAYER will win CARRYOVER POOL #1 and C CARRYOVER POOL #2.

In a third example, if two PLAYERS score the MAXIMUM SCORE, they split the payoff but neither receives CARRYOVER POOL #1 or CARRYOVER POOL #2. Both CARRYOVER POOL #1 and CARRYOVER POOL #2 roll over to the next GAME.

ARTICLE 20. The DIVIDEND of the GAME neither will generate interest nor will it be subject to monetary correction or adjustments by inflation.

ARTICLE 21. Winning TICKETS will be paid to the PLAYER after the last VALID RACE is confirmed and once the official DIVIDEND is announced. TICKETS are paid when an original ticket is presented and its validity is confirmed.

Insofar as allowed by local law, winners will have to lend themselves gratuitously for the advertising that is required by the RACETRACK or the OPERATOR in order to promote the winner of the GAME for a period of time, preferably three (3) months. Any winner who accepts payment of the DIVIDEND, will not receive the DIVIDEND until the winner has fulfilled the advertising requirements. The RACETRACK can decide any other procedure to carry out the payment of the DIVIDEND to the winning tickets by the request of the OPERATOR.

ARTICLE 22. The right to receive the DIVIDEND of the winning plays or combinations in the GAME expires after ten (10) continuous days from the date of the MEETING.

ARTICLE 23. Any modification to the order of arrival by any cause subsequent to the date of the race, will not alter the OFFICIAL ORDER OF FINISH for calculation of the DIVIDEND, the WINNER and CARRYOVER POOL #1 and CARRYOVER POOL #2.

ARTICLE 24. When a PLAYER participates in the GAME and makes a BET, the PLAYER implies the player's acceptance and adhesion to RULES. The RULES can be printed on a sign, displayed on a computer, or given upon request on a pamphlet. The acceptance should not necessarily be based on printing of rules on the TICKET.

ARTICLE 25. The Race courses and the Operator Company will not be responsible for any acts of the PLAYER may affect the validity of the TICKET.

ARTICLE 26. A TICKET CLERK of the GAME is not obliged to warn PLAYERS of errors that may occur, even if the errors affect the validity of the TICKET.

ARTICLE 27. The DIVIDEND of those TICKETS that cannot be identified or be confirmed will not be paid. The same applies to TICKETS that are illegible, doubtful, perforated or with scrapings that do not allow their clear identification. TICKETS will not be paid if they show amendments, breaks, adulterations, alterations, incompletes, unauthorized signatures, falsifications, modifications, or forgeries.

ARTICLE 28. The PICKS on a TICKET will be valid if they are validated by the OPERATOR by comparing the identifier on the TICKET.

ARTICLE 29. The minimum age of PLAYERS is set by the SANCTIONING BODY. PLAYERS beneath the minimum age cannot be paid a DIVIDEND.

ARTICLE 30. Players who wish to file a complaint must do so personally at the Operator's representative offices.

ARTICLE 31. Any complaint must be presented during business hours within a given number of days, preferably five (5) days from the last VALID RACE.

What is claimed is:

1. A method for awarding a winning player in a game of picking qualifying entries in a plurality of races, which comprises:
recording a set of picks for each of a plurality of players, each of said set of picks including a potential qualifying entry in at least one of the plurality of races;
collecting a payment from each of said plurality of players;
providing a point to a given one of said plurality of players whenever said set of picks has a qualifying finish in a given one of said races;
aggregating said points earned from said races into a point total;
picking a winner from said players having said point total with a highest number of said points; and
paying at least a portion of said payment from each of said players to said winner.

2. The method according to claim 1, wherein said races are horse races.

3. The method according to claim 1, wherein said plurality of races occur in only one meeting.

4. The method according to claim 1, wherein said qualifying entry is one of a winning entry, a placing entry, and a showing entry.

5. The method according to claim 1, which further comprises picking only one entry per race in said set of picks.

6. The method according to claim 1, which further comprises:
including a winning entry and another entry in said qualifying entries; and
awarding said player more points when a given one said picks is a winning entry than when said given one of said picks is said another entry.

7. The method according to claim 1, which further comprises:
including a winning entry, a placing entry, and a showing entry in said qualifying entries;
awarding said player more points when a given one of said picks is a winning entry than when said given one of said picks is a placing entry or a showing entry; and
awarding said player more points when said given one of said picks is a placing entry then when said given one of said picks is a showing entry.

8. The method according to claim 1, which further comprises not awarding points for an entry that is a non-qualifying entry.

9. The method according to claim 7, which further comprises:
awarding a given point amount when said given one of said picks is a showing entry;
awarding two times said given point amount when said given one of said picks is a placing entry; and
awarding five times said given point amount when said given one of said picks is a winning entry.

10. The method according to claim 1, wherein said plurality of races includes at least five races.

11. The method according to claim 10, wherein said plurality of races includes six and only six races.

12. The method according to claim 1, wherein said plurality of races includes a final race at a given meeting.

13. The method according to claim 1, wherein said plurality of races includes a first race at a given meeting.

14. The method according to claim 1, wherein said plurality races are contiguously occurring races at a given meeting.

15. The method according to claim 1, which further comprises:
collecting a wager from each of said players to form a stake; and
paying a portion of said stake to said winner.

16. The method according to claim 1, wherein said portion is fifty five percent of said stake.

17. The method according to claim 1, which further comprises:
collecting a wager from each of said players into a stake; and
paying a portion of said stake to said winner when only one of said players has said highest number of said points.

18. The method according to claim 17, wherein said portion is two and a half percent of said stake.

19. The method according to claim 17, which further comprises:
not paying said portion to any of said players when more than one of said players has said highest number of points; and
carrying over said portion to a subsequent game.

20. The method according to claim 19, which further comprises:
conducting said subsequent game;
collecting a stake of said subsequent game;
paying a portion of said stake of said subsequent game to a winner of said subsequent game when only one of said players of said subsequent game has said highest number of said points; and
paying said portion of said game to said winner of said subsequent game when only one of said players of said subsequent game has said highest number of said points.

21. The method according to claim 1, which further comprises:
collecting a wager from each of said players into a stake;
paying a portion of said stake to said winner when said winner has a maximum possible amount of said points.

22. The method according to claim 21, wherein said portion is two and a half percent of said stake.

23. The method according to claim 21, which further comprises only paying said portion of said stake when only one of said players has said maximum possible amount of said points.

24. The method according to claim 21, which further comprises rolling over said portion to a subsequent game when said portion is not paid in said game.

25. The method according claim 24, which further comprises:
conducting said subsequent game;
collecting a stake of said subsequent game;
paying a portion of said stake of said subsequent game to a winner of said subsequent game when only one of said players of said subsequent game has said maximum possible points; and
paying said portion of said game to said winner of said subsequent game when only one of said players of said subsequent game has said maximum possible points.
